(19) United States
(12) Patent Application Publication
(10) Pub. No.: US 2005/0004816 A1
(43) Pub. Date: Jan. 6, 2005

(54) Method and apparatus for processing and outputting a version change for a data record which includes medical therapeutic advice items

(76) Inventors: Klaus Abraham-Fuchs, Erlangen (DE); Eva Rumpel, Erlangen (DE); Sven Tiffe, Wien (AT)

Correspondence Address: HARNESS, DICKEY & PIERCE, P.L.C., P.O.BOX 8910, RESTON, VA, 20195, US

(21) Appl. No.: 10/849,040

(22) Filed: May 20, 2004

(30) Foreign Application Priority Data
May 20, 2003 (DE) 10322684.2

(51) Int. Cl. G06F 17/60; G06F 7/00; G06F 17/00; G08B 5/00

(52) U.S. Cl. 705/3; 340/815.4; 707/100

(57) ABSTRACT

A method is for processing a version change for a data record including medical therapeutic advice items. A respective data record, associated with a therapeutic advice item, includes a metadata structure having a number of metadata items which are checked for their respective update status. An identified changed update status is used to activate the data record in question.

The present application hereby claims priority under 35 U.S.C. §119 on German patent application number DE 103 22 684.2 filed May 20, 2003, the entire contents of which are hereby incorporated herein by reference.

### FIELD OF THE INVENTION

The invention generally relates to a method and an apparatus for processing and outputting a version change for a data record which includes medical therapeutic advice items. The data record is itself referred to as a therapeutic advice item below for short. The data record may include both data items, that is to say therapeutic advice items, and executable code, that is to say software fragments, e.g. in the form of expert rules. Generally, a database stores a plurality of data records for various medical therapeutic advice items.

### BACKGROUND OF THE INVENTION

In recent years, “medical guidelines” (medical practice guidelines or clinical practice guidelines), guidelines for short, have become increasingly significant. Guidelines are diagnostic and/or therapeutic recommendations for action and decisions (subsequently referred to as therapeutic advice items in general and in summary) to the doctor which have been drawn up in a broad consensus by superordinate and generally recognized committees in the medical profession. Naturally, such therapeutic advice items need to be continually brought into line with the latest level of knowledge and are thus subject to continual, if normally long or medium term, change. Typically, therapeutic advice items are revised and brought into line at intervals of a few years. That is to say, a medic, i.e. a doctor, therapist or the like, who treats patients, when making diagnostic and therapeutic decisions, on the basis of such established diagnostic and therapeutic advice items, is now confronted by the challenge of obtaining an overview of what therapeutic advice items are now current or whether a therapeutic advice item which is already being used for treatment has been changed in the meantime.

For a detailed explanation of the therapeutic advice items and also of their dependences and interactions, reference is made to the patent application entitled “Method for referencing data records which include therapeutic advice items” (corresponding to German patent application number DE 103 22 687.7 filed May 20, 2003) and also “Method for linking data records which comprise medical therapeutic advice items” (corresponding to German patent application number DE 103 22 683.4 filed May 20, 2003), submitted by the same applicant on the same date as the present application, the entire contents of each of which are hereby incorporated herein by reference.

To solve these problems, no automatically executable methods have been disclosed in the prior art to date to the best of the applicants' knowledge. In addition, the broad use of therapeutic advice items, particularly in the form of guidelines, in medicine is just in the process of originating.

### SUMMARY OF THE INVENTION

An embodiment of the invention relates to an improvement in the options for use of data records which include therapeutic advice items, by demonstrating a possible way of outputting and distributing the complex and comprehensive data records in simplified and updated form and hence of allowing patients to be treated on the basis of the current level of medicine, particularly of specifying an apparatus for automatically outputting updated data records.

A method is for processing and outputting a version change for a data record which includes medical therapeutic advice items. The method assigns, for the respective data record associated with a therapeutic advice item, a metadata structure having a number of metadata items which are checked for their respective update status. An identified changed update status is used to activate the data record in question by producing a warning for the data record in question.

In its most general form, a data record for a therapeutic advice item includes a collection of data items—such as input and/or output variables for therapeutic information items and a number of expert rules—which are used to generate a therapeutic advice item using the expert rules on the basis of therapeutic information items, e.g. using patient data items and/or using data items relating to available diagnostic and/or therapeutic device/method/etc. The therapeutic information items are provided in the form of input or user data in order to generate the therapeutic advice item.

In addition, the data record may be provided with a reference which is used, by way of example, to access a subsequent data record for the purpose of generating a further subsequent therapeutic advice item or is used to access subsequent data items, such as therapeutic information items, e.g. to access further necessary patient data items and/or necessary expert rules, for the purpose of complementing the therapeutic advice item in question. The therapeutic advice item is subsequently generated and output using an implicit and/or explicit metadata structure having a number of metadata items such that the metadata items are output concisely and precisely in the form of graphical and/or alphanumeric information items. In this case, the respective metadata items have an associated update status which is checked for any change or for currency upon output, with an identified changed update status resulting in activation of a corresponding output for the data record associated with the therapeutic advice item in the form of a warning.

Depending on the respective therapeutic advice item, that is to say the respectively activated output, different continuation options may arise for the therapeutic advice item. By way of example, the warning may be that the activated output is used to generate a distribution list, e.g. an electronic mail distribution list, for forwarding the information about the change in the therapeutic advice item to other users. Alternatively, the warning may be that at least one output of the data record associated with the therapeutic advice item in question is assigned a reference to a data record associated with a subsequent therapeutic advice item in the treatment process. Thus, the subsequent therapeutic advice item is informed about the version change for the preceding therapeutic advice item.

An embodiment of the invention is based on the insight that the use of modern information and communication technology is currently being greatly expanded in the health service in parallel and independently of the introduction of guidelines in medicine. The use of electronic data processing in hospitals (e.g. HIS=Hospital Information System, RIS=Radiology Information System, PACS=Picture Archive & Communication System, LIS=Laboratory Information System) and in doctor's practices (practice management software, electronic patient records) is becoming more and more usual. A subsequent development step is generally expected to network this software and these databases across the institutions in the health service (clinics, doctor's practices, therapeutic practices etc.). This provides the option of a “networked health service”, at first at national or regional level and later globally. This development provides the basis for use of the two aspects of embodiments of the invention.

An advantage of at least one embodiment of the invention and its refinements is, in particular, that complete treatment processes with individual treatment sequences can be checked and monitored for their validity period and/or their currency. This makes the use of therapeutic advice items even more attractive to medics, that is to say doctors, therapists etc. In particular, this involves monitoring data items which are normally displayed in the manner of an imprint only when called and are thus not displayed in daily dealings with the program. Monitoring of such “hidden” data items and/or information items means that, when they change, activation of the data record allows simple, safe and fast identification of changed or updated and/or newly added data items or information items.

Metadata items are understood to mean structured data items which describe the properties of data records and produce the context in terms of content. Metadata items include information items and details allowing a data record to be understood and to be made interchangeable with other users. Metadata items which describe therapeutic advice items may be, by way of example, title, author's name, date of publication, degree of evidence. In this case, metadata items in a defined machine readable format allow automatic identification and classification and direct output of a version change for a data record which comprises therapeutic advice items. Thus, by way of example, the change in the “date of publication” metadata item clearly points to a version change for a therapeutic advice item. In addition, the metadata items may have been stored in the prescribed format in the data record in this case.

In another possible embodiment, the data record is activated when new metadata items with a changed update status are read into the data record. By way of example, the data record or a module which includes the therapeutic advice item whose form and/or content has been changed is automatically activated when the changed data record or module in question is read into a database, with the type and design of the database governing whether the previous data record, which is now obsolete, is overwritten or is archived with an appropriate identifier. The activation of the new changed data record with the current therapeutic advice item, for example in the form of an output which has been set, is used for automatically generating and outputting a notification in the form of an electronic message and/or information distribution list, e.g. an e-mail distribution list.

Alternatively or in addition, the use of a changed and now updated data record may involve metadata items with a changed update status being used to activate the data record. This ensures that when an updated therapeutic advice item is called by a user, e.g. a doctor or therapist, by way of activation of the data record, e.g. in the form of an output which has been set, there is automatically a display or report with an appropriate indication of the changed update status. Such an automatic change indication results in safe and constantly current and precise dealings by the users with the currently valid therapeutic advice items, without any time consuming searching.

In one preferred embodiment, the metadata items with a changed update status and/or those portions of the data record which are characterized by these metadata items are output in modified form. Expediently, the metadata items with a changed update status and/or those portions of the data record which are characterized by these metadata items are output in visually modified form. By way of example, the information items which are output in a window and relate to the metadata items are graphically highlighted, e.g. by an appropriate color, a contrast or a border, etc. In this case, it is always just those data elements of the metadata items which have changed since the last version change or since the last update status which are graphically highlighted. Alternatively or in addition, the metadata items may be output in a separate field.

In another preferred embodiment, the metadata items with a changed update status and/or those portions of the data record which are characterized by these metadata items are output in audiovisually modified form. In this case, in addition to the graphical animation of the metadata items, output thereof also involves an audio and/or voice signal being output which advises the user of the therapeutic advice item in question that there has been a change in the form of a report signal or a voice message.

Depending on the scope of the change in the therapeutic advice item, the metadata items with a changed update status and/or those portions of the data record which are characterized by these metadata items may be output in grouped form or separately. Alternatively or in addition, particularly in order to document a user's awareness of the changes, the metadata items with a changed update status are advantageously output, and/or those portions of the data record which are characterized by these metadata items are output, in interactively modified form.

So that a user is aware of the changed update status, a confirmation request is expediently output interactively. In this case, a user's awareness of the changed therapeutic advice item involves a confirmation being input using the confirmation request which has been output. Preferably, this confirmation of awareness is documented by storing the confirmation of awareness in the data record in question. Alternatively or in addition, the confirmation may also be stored centrally in a central file.

As a result of frequently changing metadata items and resultant modified output of the metadata items in question, some confusion may arise for a user when a therapeutic advice item with multiple changes is output. To prevent this, the confirmation which has been input by the user is preferably used to reset the modified output of the metadata items in question and/or the modified output of portions which are characterized by these metadata items. Depending on the type and design of the database or of the respective data record, the modified output of metadata items in question and/or of portions which are characterized by these metadata items may be reset on a user related and/or time related and/or event related basis. That is to say, the modified metadata items are reset for each individual user separately.

Alternatively or in addition, the reset may take place after a time has elapsed, e.g. after one month has elapsed after the changed data record has been read in. The reset may also take place on the basis of a maximum value for the number of changed metadata items which have been output in modified form. By way of example, no more than five different changes may be output in modified form simultaneously. In other words: the modified output of the metadata items in question is advantageously also reset after a prescribed time has elapsed and/or under event control.

To allow, in particular, rapid use of updated therapeutic advice items which takes into account the change, particularly in large institutions such as hospitals, an identified changed update status expediently involves the output of an information report, automatically or under event control, to current and/or stored users of the therapeutic advice item in question. The method described above both for identifying and for outputting updated therapeutic advice items is advantageously also used for training and developing users, such as therapists or doctors.

An exemplary illustrative non-limiting embodiment of the invention is explained in more detail below with reference to the drawings. Articles or elements which correspond to one another have been provided with the same reference symbols in all figures.

In the drawings:

FIG. 1 schematically shows a structure for a data record which includes at least one therapeutic advice item,

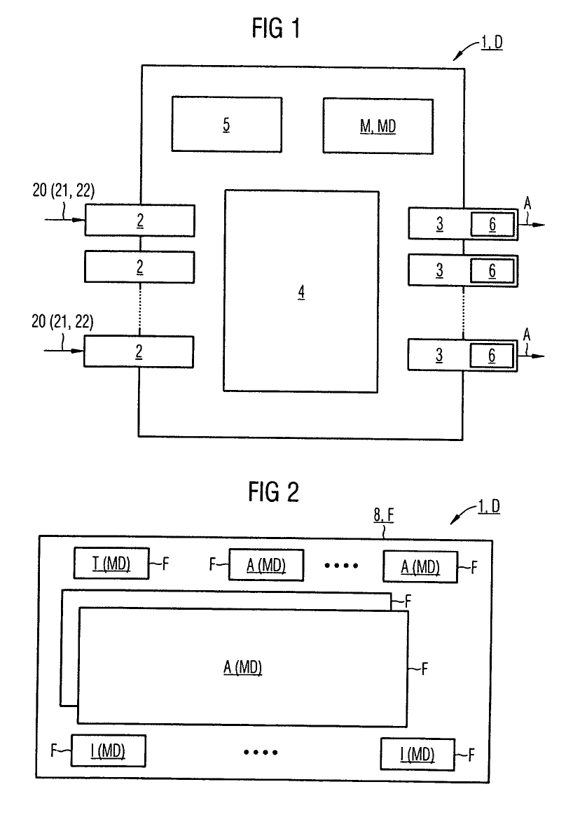

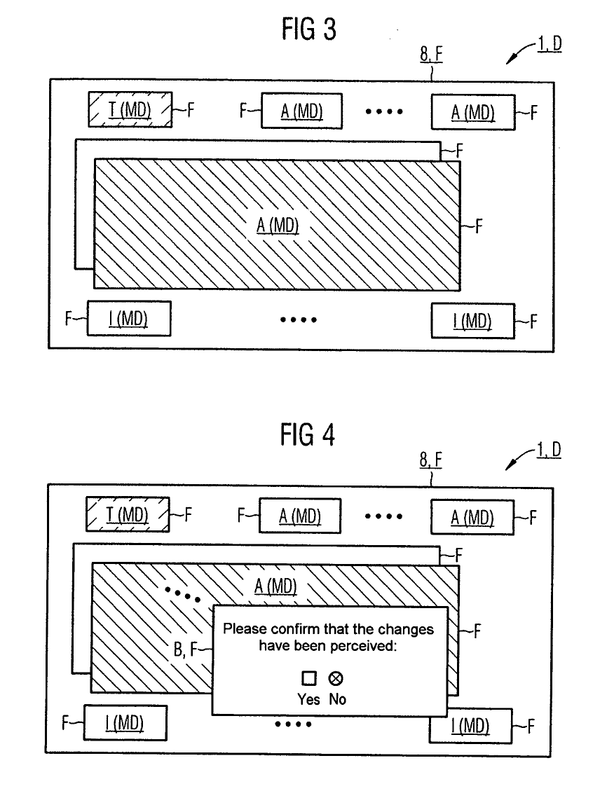

FIGS. 2 to 3 show a schematic illustration of various alternative embodiments for outputting a data record which includes at least one therapeutic advice item, and

FIG. 4 shows further modified output of metadata items MD for the purpose of identifying and displaying the change in the underlying update status

Parts which correspond to one another have been provided with the same reference symbols in all figures.

### DETAILED DESCRIPTION OF THE PREFERRED EMBODIMENTS

FIG. 1 shows a schematic illustration of the software implementation of the basic structure of a medical guideline, using a data record D for a therapeutic advice item 1. The data record D (subsequently called only therapeutic advice item 1 for short) comprises at least one input 2 (also called input variable) and at least one output 3. The or each input 2 is used to supply therapeutic information items 20, such as patient data items 21 or information items 22, directly or indirectly to the therapeutic advice item 1 using diagnostic and/or therapeutic method/device, etc.

The core of the therapeutic advice item 1 is formed by an expert rule 4. The expert rule 4, which is in turn characterized by way of a metadata structure M with a plurality of metadata items MD, is used to activate single or a plurality of outputs 3 on the basis of the therapeutic information items 20 at the or each input 2, and hence to output individual, i.e. patient or device related, action and/or decision recommendations A in the form of procedures or action instructions.

The therapeutic information items 20 at an input 2, that is to say the patient data items 21 or information items 22, may be from various categories, e.g. measured data items such as blood pressure, electrocardiogram, available technical methods/devices/etc., such as X-ray machine etc., findings such as a previous diagnosis or actions such as a therapeutic option which has been implemented etc. Similarly, the individual action and/or decision recommendations A which are output at the outputs 3 may be from various categories, e.g. a finding such as a diagnosis derived from the input values for the therapeutic information item 20, an action recommendation or examination results derived from input data for the therapeutic information item 20.

The expert rule 4 is generally an “inference rule” which is used to derive from the therapeutic information items 20 (also called input data items) single or a plurality of individual—patient and/or means related—action and/or decision recommendations A which result in activation of the respective output 3 or of the respective outputs 3 and may be output at the output(s).

In the exemplary embodiment, every therapeutic advice item 1 may also include an order feature 5 which clearly identifies the therapeutic advice item 1. The order feature 5 is suitable and provided for referencing a therapeutic advice item 1 which, by way of example, is stored in a central database (not shown) and is used in a medical institution.

To identify a change, e.g. a change in the form and/or content of the therapeutic advice item 1, reading in or generating the therapeutic advice item 1 involves said therapeutic advice item 1 being analysed, on the basis of the metadata structure M with metadata items MD, for the update status thereof. In this case, an identified changed update status for one of the metadata items MD is used to activate the data record D and hence the therapeutic advice item 1 by setting an output A, for example, as a warning. The output A which has been set can be used, by way of example, for automatically generating a notification about the changed and current therapeutic advice item 1 in the form of an electronic message and/or information distribution list, e.g. an e-mail distribution list, and outputting it to other users.

It is thus possible for the identification and output of the change in a therapeutic advice item 1 to be incorporated directly into workflows in relatively large institutions with related doctors and/or therapists. As such, the users using this changed therapeutic advice item 1 within such a complex or network are notified automatically and a report is automatically output using the output A on the basis of activation of the data record D when a changed therapeutic advice item 1 is called and hence used by one of the users in this complex or in this network.

Metadata items MD are understood to mean data items which are structured in a metadata structure M and give a more detailed description of the properties of the respective data record D associated with the therapeutic advice item 1 in question and produce the context in terms of content. By way of example, metadata items MD comprise information items and details which allow a data record D to be understood and made interchangeable with other users. Metadata items MD which describe therapeutic advice items 1 may be, by way of example, title, author's name, data of publication, degree of evidence. In this regard, the metadata items MD are stored in a defined machine readable format in the data record D and, in this context, allow automatic identification and classification and direct output of a version change for the data record D associated with the therapeutic advice item 1 in question. Thus, by way of example, the change in the metadata item MD “date of publication” points clearly to a version change for a therapeutic advice item 1.

Normally, the metadata items MD are “hidden” information items or data items which are automatically checked for any change using the update status associated with the metadata items MD, so that the therapeutic advice item 1 is automatically activated in the event of an identified change. Hidden data items or information items are understood to mean, by way of example, imprint information items such as a change in the edition or version or the name of the author of the therapeutic advice item 1.

These information items are normally not output directly on a screen. Instead, they are usually stored in a field which can be called up or in a display which can be called up, so that these information items or data items are not checked for currency in the course of everyday dealings. This is the starting point for the automatic check of the data items which are contained in the data record D and describe the therapeutic advice item 1 in more detail, but are not output, using the associated metadata items MD, so that a change in such “hidden” data items automatically prompts activation of the therapeutic advice item 1 in question, and users in question are issued a report or notified automatically, for example.

Thus, depending on the function and design of the respective output 3, activation thereof allows it to use the changed metadata items MD firstly to output action and/or decision recommendations A in modified form, in the form of the output of modified metadata items MD, and secondly to bring about a reference 6 for referencing a further therapeutic advice item 1. If no output or no further therapeutic advice item 1 is intended to be linked to the activation of an output 3, the value of the reference 6 is set to a prescribed value, e.g. zero. If an output or a subsequent therapeutic advice item 1 is intended to be linked to the activation of an output 3, then an appropriate output device 8, as shown in FIG. 2, is actuated and its order feature 5 is entered as reference 6.

FIG. 2 shows an example of metadata items MD associated with a therapeutic advice item 1 being output on an output device 8. The output device 8 used is a screen or a printer, for example. For audiovisual output of changed metadata items MD, particularly of information items or data items on which these metadata items are based, a loudspeaker (not specifically shown) is provided, for example, which outputs an audio signal in the form of a voice message or a tone. Alternatively, a report in the form of an electronic message, e.g. as e-mail, may also be output.

In this case, the various information items or data items on which the respective metadata items MD are based, e.g. the title T of the therapeutic advice item 1, the author(s) N, or other information I, such as date of output of the therapeutic advice item 1, degree of evidence in the action and/or decision recommendation A, are output on the output device 8, on a screen or printer in appropriate fields or display windows F of a display. In this context, the display shown in FIG. 2 is just one possible arrangement of the display windows F. Depending on the type, content, scope and number of therapeutic advice items 1 which are to be displayed, any other arrangement and also size of display windows F may be provided.

To be able to identify the display windows F which are output on the output device 8 and their associated update status to a user easily and safely, i.e. to display to a user a possible version change—both in terms of form and in terms of content—such as a change in the validity period or in an expiry date, a change in the name of the author(s), a change in the prioritization of action and decision recommendation A, a degree of evidence in this action and decision recommendation A, in the underlying therapeutic advice item 1—the generation and subsequent output of the information items or data items which form the basis of the metadata items MD and represent the therapeutic advice item 1 involve the metadata items MD being analyzed, and correspondingly activated such that metadata items MD having a changed update status are output in appropriately modified form on the basis of the associated information items and data items.

FIG. 3 shows, by way of example, modified output of metadata items MD and, in addition, modified output of an action and decision recommendation A, having a new update status, in the form of a display window F which is visually, particularly graphically, highlighted by a line pattern, for example. By way of example, the changed metadata items MD, particularly the information items or data items on which these are based, may also be visually highlighted by use of an appropriate color, by use of a contrast and/or by use of a border, etc., when they are output.

Depending on the number and type of metadata items MD which have a changed update status, a plurality of display windows F may also be output in modified form. By way of example, FIG. 3 also shows appropriate graphical highlighting for the display window F for the title T, which has changed with the new version. In addition or alternatively, generation of the therapeutic advice item 1 and subsequent output on the output device 8 may also involve a signal, e.g. a tone signal or a voice message, being output in order to output a change in the update status in audiovisual form. To this end, an output A for the therapeutic advice item 1 is used to supply a corresponding control signal to a loudspeaker or to another audio unit.

Depending on the type and preset, modified output of the information items or data items on which the metadata items MD are based may involve, in order to improve the clarity of the display, visually and/or audiovisually modified output of just those metadata items MD—on the basis of the associated information items or data items—which have changed since the last, i.e. previous, update status. It is also possible for changed metadata items MD, particularly their information items or data items, to be output in grouped form in a joint display window F or separately.

FIG. 4 shows further modified output of metadata items MD for the purpose of identifying and displaying the change in the underlying update status. In this context, the change in the update status of the metadata items MD is output preferably by outputting a display window F in interactively modified form. That is to say that, in addition to the actual output of the information items or data items on which the metadata items MD are based in the associated display window F, a confirmation request B may be output by opening an associated display window F in which the user of the changed therapeutic advice item 1 needs to confirm that he is aware of the changed therapeutic advice item 1 by making an appropriate input in the associated display window F. Advantageously, input of the confirmation for the user's awareness of the changed therapeutic advice item 1 is documented by storing the confirmation in the associated data record D and/or in a central data store (not shown in more detail).

In order to prevent the display from being confusing as a result of too high a number of modified metadata items MD, provision is made for the visually and/or audiovisually highlighted output of the relevant information items or data items associated with the metadata items MD to be reset, for example upon input of the confirmation of awareness by the user. That is to say that only the modified output, particularly representation, is reset to a normal output. The changed and/or updated content of the information items or data items in question is maintained.

Alternatively or in addition, the highlighted output of the metadata items MD may be reset when a prescribed time has elapsed, e.g. when one month has elapsed after the therapeutic advice item 1 has changed, and/or under event control, e.g. when a maximum number of changed metadata items MD for one or more therapeutic advice items 1 has been exceeded. In this case too, only the formal, i.e. the modified, output is reset to a normal and unconfusing output, the content changes in the information items and data items in question and in the associated metadata items MD being maintained.

In this case, resetting may also be understood to mean that the usually hidden data items and information items are output only for a certain time or during a request for confirmation that a user is aware of them, and are stored out of sight again in the data record D when the time has elapsed or when they have been confirmed.

In one preferred instance and/or embodiment of application of the inventive method, the method is used for training and development, for example in the form of teaching software. In this case, additional display windows F in the form of interactive fields may be generated and output which can be used interactively by the user to call up and answer questions and answers for understanding changes in the therapeutic advice item 1. It is also possible to generate and output display windows F comparing old and new metadata items MD associated with the therapeutic advice item 1. Alternatively or in addition, the respective update status may be used by an implemented search algorithm to identify and output—in joint, grouped and/or serial form—those metadata items MD which have changed since the last update status or with respect to a prescribed, previous update status.

Any of the aforementioned methods may be embodied in the form of a program. The program may be stored on a computer readable media and is adapted to perform any one of the aforementioned methods when run on a computer. Thus, the storage medium or computer readable medium, is adapted to store information and is adapted to interact with a data processing facility or computer to perform the method of any of the above mentioned embodiments.

The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for processing a data record including at least one medical therapeutic advice item, the method comprising:
assigning a respective data record, associated with a therapeutic advice item, a metadata structure including a plurality of metadata items which are checked for a respective update status, wherein an identified changed update status for the respective data record is used to produce a warning.

2. The method as claimed in claim 1, wherein the warning is generated, activated and output on a display window of an output device.

3. The method as claimed in claim 1, wherein the warning produced is an electronic message.

4. The method as claimed in claim 1, wherein the warning produced is output as at least one of an audible and a visual signal.

5. The method as claimed in claim 2, wherein the data record is activated on the output device when new metadata items with a changed update status are read into the data record.

6. The method as claimed in claim 2, wherein use of the data record involves metadata items with a changed update status being used to activate the data record on the output device.

7. The method as claimed in claim 1, wherein at least one of metadata items with a changed update status and portions of the data record characterized by the metadata items, are output on an output device in modified form.

8. The method as claimed in claim 1, wherein at least one of metadata items with a changed update status and portions of the data record characterized by the metadata items are output on an output device in visually modified form.

9. The method as claimed in claim 1, wherein at least one of metadata items with a changed update status and portions of the data record characterized by the metadata items are output on an output device in audiovisually modified form.

10. The method as claimed in claim 1, wherein at least one of metadata items with a changed update status and portions of the data record characterized by the metadata items are output on an output device in at least one of separately and in grouped form.

11. The method as claimed in claim 1, wherein at least one of metadata items with a changed update status and those portions of the data record characterized by the metadata items are output on an output device in interactively modified form.

12. The method as claimed in claim 11, wherein a user is made aware of the changed update status by the output of a confirmation request interactively on the output device.

13. The method as claimed in claim 12, wherein, when a user is aware, the output confirmation request is used to input a confirmation on the output device.

14. The method as claimed in claim 13, wherein the confirmation of awareness is stored in the respective data record.

15. The method as claimed in claim 13, wherein the confirmation is input and is used to reset the modified output of the at least one of metadata items and portions characterized by the metadata items, on the output device.

16. The method as claimed in claim 2, wherein, at least one of after a prescribed time has elapsed and under event control, the modified output of at least one of the metadata items and portions characterized by the metadata items is reset on the output device.

17. The method as claimed in claim 2, wherein an identified changed update status involves the output of an information report on the output device, automatically or under event control, to at least one of current and stored users of the respective therapeutic advice item.

18. The method as claimed in claim 1, wherein the metadata items are stored in the data record in a prescribed format as information items, particularly title (T), author's name (N), date of publication, prioritized therapeutic recommendation, which represent the therapeutic advice item (1) in question.

19. The method as claimed in claim 1, further comprising using the method for training and developing users of data records including at least one therapeutic advice item.

20. An apparatus for carrying out the method as claimed in claim 1, comprising an output device for outputting the produced warning in the event of a version change for the data record using an identified changed update status.

21. The apparatus as claimed in claim 20, wherein the output device is in the form of at least one of a printer, a screen, a loudspeaker and a modem.

22. The method of claim 1, further comprising:
processing and outputting a version change for a data record.

23. The method as claimed in claim 2, wherein the warning produced is an electronic message.

24. The method as claimed in claim 2, wherein the warning produced is output as at least one of an audible and a visual signal.

25. The method as claimed in claim 3, wherein the warning produced is output as at least one of an audible and a visual signal.

26. A method for processing a data record including at least one medical therapeutic advice item, the method comprising:
assigning a respective data record, associated with a therapeutic advice item, a metadata structure including a plurality of metadata items;
checking the plurality of metadata items for an update in status; and
using an identified change in update status to produce a warning.

27. The method of claim 26, further comprising:
processing and outputting a version change for a data record.

28. The method as claimed in claim 26, wherein the warning is generated, activated and output on a display window of an output device.

29. The method as claimed in claim 26, wherein the warning produced is an electronic message.

30. The method as claimed in claim 26, wherein the warning produced is output as at least one of an audible and a visual signal.

31. The method as claimed in claim 2, wherein at least one of metadata items with a changed update status and portions of the data record characterized by the metadata items, are output on the output device in modified form.

32. The method as claimed in claim 2, wherein at least one of metadata items with a changed update status and portions of the data record characterized by the metadata items are output on the output device in visually modified form.

33. The method as claimed in claim 2, wherein at least one of metadata items with a changed update status and portions of the data record characterized by the metadata items are output on the output device in audiovisually modified form.

34. The method as claimed in claim 2, wherein at least one of metadata items with a changed update status and portions of the data record characterized by the metadata items are output on the output device in at least one of separately and in grouped form.

35. The method as claimed in claim 2, wherein at least one of metadata items with a changed update status and those portions of the data record characterized by the metadata items are output on the output device in interactively modified form.

36. The method as claimed in claim 28, wherein at least one of metadata items with a changed update status and portions of the data record characterized by the metadata items, are output on the output device in modified form.

37. The method as claimed in claim 28, wherein at least one of metadata items with a changed update status and portions of the data record characterized by the metadata items are output on the output device in visually modified form.

38. The method as claimed in claim 28, wherein at least one of metadata items with a changed update status and portions of the data record characterized by the metadata items are output on the output device in audiovisually modified form.

39. The method as claimed in claim 28, wherein at least one of metadata items with a changed update status and portions of the data record characterized by the metadata items are output on the output device in at least one of separately and in grouped form.

40. The method as claimed in claim 28, wherein at least one of metadata items with a changed update status and those portions of the data record characterized by the metadata items are output on the output device in interactively modified form.

41. The method as claimed in claim 1, wherein the metadata items are stored in the data record in a prescribed format as information items, including at least one of a title, author's name, date of publication, and prioritized therapeutic recommendation, which represent the respective therapeutic advice item.

42. An apparatus for processing a data record including at least one medical therapeutic advice item, the apparatus comprising:
means for assigning a respective data record, associated with a therapeutic advice item, a metadata structure including a plurality of metadata items which are checked for a respective update status; and
output means for producing a warning using a changed update status for the respective data record, upon such a changed update status being identified.

43. The apparatus as claimed in claim 42, wherein the output means includes at least one of a printer, a screen, a loudspeaker and a modem.

44. An apparatus for processing a data record including at least one medical therapeutic advice item, the apparatus comprising:
means for assigning a respective data record, associated with a therapeutic advice item, a metadata structure including a plurality of metadata items;
means for checking the plurality of metadata items for an update in status; and
means for producing a warning using an identified change in update status.

45. The apparatus as claimed in claim 44, wherein the means for producing a warning includes at least one of a printer, a screen, a loudspeaker and a modem.

46. A program, adapted to perform the method of claim 1, when executed on a computer.

47. A computer readable medium, storing the program of claim 46.

48. A program, adapted to perform the method of claim 26, when executed on a computer.

49. A computer readable medium, storing the program of claim 48.
